(19) United States
(12) Patent Application Publication
(10) Pub. No.: US 2012/0192897 A1
(43) Pub. Date: Aug. 2, 2012

(54) METHOD AND DEVICE FOR WORK INSIDE PIPES

(76) Inventor: Fukashi Urakami, Kanagawa (JP)

(21) Appl. No.: 13/389,908

(22) PCT Filed: Aug. 3, 2010
(86) PCT No.: PCT/JP2010/063051

§ 371 Date: Mar. 29, 2012

(30) Foreign Application Priority Data
Aug. 11, 2009 (JP) 2009-186177

(51) Int. Cl. F16L 55/28; B08B 9/049

(52) U.S. Cl. 134/8; 15/3.5

(57) ABSTRACT

PROBLEM TO BE SOLVED: To provide “working device for internal pipe and working method for the same” characterized in that the travelling force in pipe is very large.

SOLUTION: The working device for internal pipe is equipped with an annular pressure boundary seal of which the free end part comes into contact with the wall of the pipe and the seal divides the internal space of the pipe into two spaces, that is, a space A and a space B using the seal as a boundary. One end part of the space A close to the seal is connected to a suction pump through a hose and also connected to the space B through a vacuum breaking valve mechanism for adjusting the negative pressure in the space A, while the other end part of the space A far from the seal is closed, and the hose is arranged in the space B.

### TECHNICAL FIELD

This invention relates to a device capable of moving along the surface of an internal pipe, having a repair device/s that acts on the surface of the internal pipe, such a repair device may be a cleaning device to remove foreign matter such as rust or aquatic organisms attached to the internal pipe such as a clear-water pipe, drainage or gas pipe.

### BACKGROUND ART

As an example of the working devices described in the above, it was disclosed the “Working method for an internal pipe and working device for the same” described in Japanese Patent Application Examined Publication No. 2003-225626.

### [Patent Reference]

Japanese Patent Publication No. 2003-225626

### DISCLOSURE OF THE INVENTION

In the working device described in the above as the “Working method for an internal pipe and working device for the same” described in Japanese Patent Application Examined Publication No. 2003-225626, there are following problems to be solved.

One of the problems of the “Working method for an internal pipe and working device for the same” is caused by the structure of the working device that the main unit of the working device moves along the internal pipe by being pulled by a rope, of which end of the rope is connected to the main unit, and another end of the rope is wound on the winch which is located outside of the end of the pipe.

According to the above structure of the working device, it is required the process to insert the rope from one end of the pipe to the other end of it, therefore the process is tiresome in such a case that the pipe is very long or there is a vent in the middle of the pipe.

Accordingly, technical objectives of the present invention are as follows.

The technical objective of the present invention is to provide the “Working device for an internal pipe and working method for the same” having the features as follows.

In the working device, the driving force for the main unit of the working device to be moved along the pipe is very large in spite of not being equipped with the winch.

Another technical objective of the present invention is to provide the “Working device for an internal pipe and working method for the same” which is applied to the pipe which has only one opening.

Further technical objective of the present invention is to provide the “Working device for an internal pipe and working method for the same” having the mechanism to make the device to travel smoothly along the inside of the pipe having a branch pipe.

In order to solve the technical problems described in the above, provided according to the present invention as described in claim 1, comprising a working device capable of moving along the surface of an internal pipe, comprising:

An annular pressure boundary seal, free-end outer portion of which comes into contact with the surface of the internal pipe, inner portion of which is fixed to the main body of the main unit of the working device;

Wherein the seal separates the space inside the pipe into two spaces, space (A) and space (B), using the seal as a boundary;

The end portion of space (A) adjacent to the seal, being connected with a suction pump via a hose;

The end portion of space (A) adjacent to the seal, being also connected with space (B) via a vacuum breaker that adjusts the negative pressure within space (A);

The other end portion of space (A), which is not adjacent to the seal, being closed;

The hose, being disposed in space (B).

In order to solve the technical problems described in the above, provided according to the present invention as described in claim 2, comprising a working device capable of moving along the surface of an internal pipe, comprising:

An annular pressure boundary seal, free-end outer portion of which comes into contact with the surface of the internal pipe, inner portion of which is fixed to the main body of the main unit of the working device;

Wherein the seal separates the space inside the pipe into two spaces, space (A) and space (B), using the seal as a boundary;

The end portion of space (A) adjacent to the seal, being connected with a delivery pump via a hose;

The end portion of space (A) adjacent to the seal, being also connected with space (B) via a relief valve that adjusts the positive pressure within space (A);

The other end portion of space (A), which is not adjacent to the seal, being closed;

The hose, being disposed in space (B).

In order to solve the technical problems described in the above, provided according to the present invention as described in claim 3, comprising:

The first process to act on the surface of the pipe, that process is carried out from space (B) toward space (A) by using the working device capable of moving along the pipe described in claims 1;

The second process to act on the surface of the pipe, that process is carried out from space (A) toward space (B) by using the working device capable of moving along the pipe described in claims 2.

In order to solve the technical problems described in the above, provided according to the present invention as described in claim 4, comprising a working device capable of moving along the surface of the internal pipe, the device having a vacuum breaking valve mechanism or a relief valve mechanism, described in Claims 1 through 3, wherein:

The annular pressure boundary seal is composed of a free-end outer portion and two inner portions, the free-end outer portion having an arc-shape in cross section, two ends of the arc-portion being fixed to the main body of the main unit of the working device, the two ends of the arc-portion being the same as the two inner portions, each end of the two ends of the arc-shaped portion extending in the direction of the surface of the pipe, the two extending portions being combined and becoming one at the most extended part;

Both of the annular pressure boundary seal and the main body of the main unit of the working device, forming a closed annular space in cooperation;

The closed annular space, being connected with a valve which injects a fluid into the space or discharges a fluid from the space;

When the negative pressure of space (A) has become excessive, the vacuum breaker drains the fluid from the annular space, subsequently the end portion of the annular pressure boundary seal is away from the inner surface of the pipe so that the volume of the annular space contraction, thus the fluid in space (B) inflows into space (A), finally the increase of the negative pressure of space (A) is prevented as a result of the above operation;

When the positive pressure of space (A) has become excessive, the relief valve drains the fluid from the annular space, subsequently the end portion of the annular pressure boundary seal is away from the inner surface of the pipe so that the volume of the annular space contraction, thus the fluid in space (A) inflows into space (B), finally the increase of the positive pressure of space (A) is prevented as a result of the above operation.

In order to solve the technical problems described in the above, provided according to the present invention as described in claim 5, comprising a means to make the working device to move along the surface of an internal pipe, wherein: The working device is equipped with a means to be moved along the pipe, that means comprising a spinning wheel unit and a non-spinning wheel unit:

The spinning wheel unit, comprising:

A plurality of non-rotating rod cylinders that is radially arranged on the outer periphery of the rotating body; Free-wheels, each of the free-wheels being equipped with the each of the non-rotating rod cylinders, each axis of the free-wheels being arranged in a cross at a small angle to the axis of the pipe;

Means to push the each of the free-wheels to the surface of the pipe, one example of the means being composed by means to supply the pressure fluid to the each of the non-rotating rod cylinders, another example of the means being composed by a compression coil spring which is placed inside the each of the non-rotating rod cylinders;

Means for synchronizing the operation of each of the piston rod of the non-rotating rod cylinders:

The non-spinning wheel unit, comprising:

A plurality of non-rotating rod cylinders that is radially arranged on the outer periphery of the non-rotating body;

Free-wheels, each of the free-wheels being equipped with the each of the non-rotating rod cylinders, each axis of the free-wheels being arranged in a cross at right angle to the axis of the pipe;

Means to push the each of the free-wheels to the surface of the pipe, one example of the means being composed by means to supply the pressure fluid to the each of the non-rotating rod cylinders, another example of the means being composed by a compression coil spring which is placed inside the each of the non-rotating rod cylinders;

Means for synchronizing the operation of each of the piston rod of the non-rotating rod cylinders:

Each of the means for synchronizing the operation of each of the piston rod of the non-rotating rod cylinders, comprising:

A swing plate that has any number of lever parts each of which is radially arranged on the outer periphery of the swing plate, the number of the lever part is the same as the number of the non-rotating rod cylinder;

Link plates with link pins each of which connects each of the lever part and each of the piston rod of the non-rotating rod cylinders.

Effects of the present invention will be explained below.

The present invention is to provide the “Working device for an internal pipe and working method for the same” having the features as follows.

In the working device, the driving force for the main unit of the working device to be moved along the pipe is very large in spite of not being equipped with the winch.

Another technical objective of the present invention is to provide the “Working device for an internal pipe and working method for the same” which is applied to the pipe which has only one opening.

Further technical objective of the present invention is to provide the “Working device for an internal pipe and working method for the same” having the mechanism to make the device to travel smoothly along the inside of the pipe having a branch pipe.

Each of the spinning wheel unit and the non-spinning wheel unit has a means for synchronizing the operation of each of the piston rod of the non-rotating rod cylinders. Each of the piston rods is equipped with the free-wheels.

Describing the usefulness of the means that all of the piston rods of the non-rotating rod cylinders move in synchronization; it is prevented by the means that only one piston rod protrudes from the other piston rods, therefore it is prevented that the working device gets stuck due to a serious situation that one of the plurality of wheels fits into a branch pipe.

### DESCRIPTIONS OF THE PREFERRED EMBODIMENTS

Preferred embodiments of the working device configured according to the present invention will be described in detail below, referring to the figures attached hereto.

In FIG. 1, the first preferred embodiment of the “Working device for an internal pipe and working method for the same” configured according to the present invention, comprising:

The main unit 2 placed inside the pipe 12;

The hose 5, of which upstream end being connected to the main unit 2, of which downstream end being connected to the upstream side inlet of the solid fluid separation device 41;

The roots type suction pump 31 as a type of the positive-displacement pumps, of which upstream inlet being connected to the downstream side outlet of the solid fluid separation device 41, of which downstream outlet being released into the inside of the manhole 14.

The stop valve 13 is connected to one end of the pipe wherein the hose 5 is not placed.

Another end of the pipe wherein placed of the hose 5 is released into the inside of the manhole 14.

The inside of the pipe 12 and the manhole 14 is filled with water.

Describes in detail the configuration of the main unit 2 placed inside the pipe 1, referring to FIG. 2 through 11, comprising:

The first cylindrical body 21 of which axis is parallel to the axis of the pipe 12, wherein;

Disposed the cylindrical cavity inside the body 21, extending in the axial direction of the pipe;

Installed the geared air motor 31 in the cavity; Installed the main drive shaft 32 in the cavity being supported by two ball bearings 33 which is fixed to the body 21, being connected to the output shaft of the geared air motor 31;

Formed the cylinder base 381 on the periphery of the central portion of the first cylindrical body 21;

Installed the four sets of the non-rotating rod cylinders 39 on the cylinder base 381 as the components of the non-spinning wheel unit 38;

Installed the high-pressure tube fitting 421 on the periphery of the right end portion of the first cylindrical body 21:

The second cylindrical body 22, placed outside the periphery of the left portion of the first cylindrical body 21, wherein;

One end of the second cylindrical body 22 being connected to the first cylindrical body 21 via the first spherical bearing 211;

Another end of the second cylindrical body 22, being expanded the aperture of the end to be formed flange-like;

Disposed several holes in the circumference of the second cylindrical body 22:

The seal fixing cylindrical body 221 to which the annular pressure boundary seal 20 is fixed, one end of the body 221 being connected to the flange of the second cylindrical body 22, another end of the body 221 being connected to the flange portion of the third cylindrical body 23:

The third cylindrical body 23, connected to the flange portion of the seal fixing cylindrical body 221:

The fourth cylindrical body 24, placed outside the periphery of the third cylindrical body 23, wherein;

One end of the fourth cylindrical body 24 being connected to the third cylindrical body 23 via the second spherical bearing 231;

The bore of another end of the fourth cylindrical body 24 being narrowed down:

The fifth cylindrical body 25, wherein;

One end of the fifth cylindrical body 25 being welded to the small bore end of the fourth cylindrical body 24;

Another end of the fifth cylindrical body 25, being wilted the aperture of the end to be formed a cylindrical shape:

The hose connector 26, one end of which being connected to the fifth cylindrical body 25 via the third spherical bearing 251:

The hose 5 connected to the hose connector 26:

The pressure boundary seal 20 formed from a flexible material such as polyurethane, being composed of a free-end outer portion 202 and two inner portions 201, the free-end outer portion 202 having an arc-shape in cross section, one end of the arc-portion being fixed and sandwiched among the flange of the second cylindrical body 22 and the flange of the seal fixing cylindrical body 221, another end of the arc-portion being fixed and sandwiched among the flange of the seal fixing cylindrical body 221 and the flange of the third cylindrical body 23, the two ends of the arc-portion being the same as the two inner portions 201, each end of the two ends of the arc-shaped portion extending in the direction of the surface of the pipe 1, the two extending portions being combined and becoming one at the most extended part:

The fluid tube fitting 222, connected to the annular space 203 which is formed to cooperate with the seal fixing cylindrical body 221 and the pressure boundary seal 20:

The non-spinning wheel unit 38, comprised of the cylinder base 381 formed on the periphery of the central portion of the first cylindrical body 21, and the four sets of the non-rotating rod cylinders 39 installed on the cylinder base 381, and etc.:

The main drive shaft 32 being incorporated with the rotary joint 34 which ensures the flow of fluid between the rotating body—the high-pressure tube fitting 42 connected to the right end of the main drive shaft 32—and the non-rotating body—the high-pressure tube fitting 42 connected to the first cylindrical body 21:

The universal joint 35 connected to the main drive shaft 32:

The spinning wheel unit 37, comprised of the cylinder base 371 formed on the periphery of the driven shaft 36 connected to the universal joint 35, and the four sets of the non-rotating rod cylinders 39 installed on the cylinder base 371, and etc.:

The high-pressure tube 431, being a concatenation of the high-pressure tube fitting 421 of the main drive shaft and the high-pressure tube fitting 421 of the driven shaft 36:

The cleaning means such as the rotating brush 49 in order to clean the inner surface of the pipe 12, equipped with the driven shaft 36:

The guide wheel unit 8, being composed of three free-wheels 41 placed outside the periphery of the fifth cylindrical body 25:

A lot of the hose guide wheel units 9, each of which being composed of three free-wheels 41 placed outside the hose 5.

It should be noted that the pressure boundary seal 20 divides the space inside the pipe 1 into space (A): A0 and space (B): B0.

The spinning wheel unit 37 and the non-spinning wheel unit 38 are placed in the space (A) is and the hose 5 is placed in the space (B).

It should be noted further that the main unit 2 of the working device of the first preferred embodiment is equipped with the vacuum breaking system that the excessive negative pressure of the space (A) is prevented by flowing the fluid into the space (A) from the space (B).

In the main unit 2 of the working device of the first preferred embodiment, the pressure boundary seal 20 is used for the valve sheet of the vacuum breaking valve system as shown in FIG. 10 though it is possible to use a known vacuum breaking valve.

Describes in detail the configuration of the spinning wheel unit 37, comprising:

Four sets of the non-rotating rod cylinders 39 being installed radially on the periphery of the driven shaft 36;

Two free-wheels 41 being installed in the each ends of the piston rods of the non-rotating rod cylinders 39:

Each axis of the free-wheels 41 is arranged in a cross at a small angle to the axis of the pipe 1.

Each of the non-rotating rod cylinders 39 has a function to push strongly the free-wheels 41 to the surface of the pipe 1.

In order to push the free-wheels to the surface, each of the non-rotating rod cylinders 39 has a compression coil spring which is placed inside each of the cylinders.

In order to push the free-wheels to the surface of the pipe 1 in another way, each of the non-rotating rod cylinders 39 may be made as a non-rotating rod air cylinder, and then the compressed air is supplied to the air cylinder via a rotary joint—not shown.

Describes in detail the configuration of the non-spinning wheel unit 38, referring to FIG. 2 through 3 and FIG. 5, comprising:

Four sets of the non-rotating rod cylinders 39 being installed radially on the outer periphery of the central portion of the first cylindrical body 21;

Two free-wheels 41 being installed in the each ends of the piston rods of the non-rotating rod cylinders 39:

Each axis of the free-wheels 41 is arranged in a cross at right angle to the axis of the pipe 1.

Each of the non-rotating rod cylinders 39 has a function to push strongly the free-wheels 41 to the surface of the pipe 1.

In order to push the free-wheels to the surface, each of the non-rotating rod cylinders 39 has a compression coil spring which is placed inside each of the cylinders.

In order to push the free-wheels to the surface of the pipe 1 in another way, each of the non-rotating rod cylinders 39 may be made as a non-rotating rod air cylinder, and then the compressed air is supplied to the air cylinder via a rotary joint—not shown.

Describes in detail the configuration of the swing lever mechanism to synchronize the operation of each of the piston rod of the four non-rotating rod cylinders of the spinning wheel unit 37 or the non-spinning wheel unit 38, comprising:

The cylinder base 371 is formed on the periphery of the driven shaft 36 of the spinning wheel unit 37;

Being welded the each cylinder case 391 of the four sets of the non-rotating rod cylinders 39 to the cylinder base 371, the piston rod of each cylinders 39 extension or contraction in the direction of radiation;

The swing plate 396 is installed rotatably on the periphery of the driven shaft 36 via the bush bearing 397;

Four protruding lever parts are formed in the periphery of the swing plate 396;

Being concatenated each of the lever parts and each of the piston rods 391 by the link pin 394 and the link plate 395, four piston rods 391 move in synchronization.

It is used the pressure boundary seal 20 for the valve sheet of the vacuum break valve system in the main unit 2 of the first preferred embodiment of this invention.

It is used the pressure boundary seal 20 for the valve sheet of the pressure relief valve system in the main unit 2 of the second preferred embodiment of this invention.

Describes in detail the configuration of the vacuum break valve system or the pressure relief valve system by using the pressure boundary seal 20, referring to FIG. 10, comprising:

The fluid tube fitting 222, connected to the annular space 203 which is formed to cooperate with the seal fixing cylindrical body 221 and the pressure boundary seal 20;

The “Master valve with three ports and two positions 205” which is connected to the fluid tube fitting 222 as shown in FIG. 10;

The “Master valve with three ports and two positions 206” arranged as shown in FIG. 10;

The preset type pneumatic output unit 207 which outputs the air pressure when the differential pressure between the pressure of the space (A): A0 and the pressure of the space (B): B0 reaches the value set in advance.

The preset type pneumatic output unit 207 is a known device.

Described the function of the “Master valve with three ports and two positions 205”, the master valve 205 selectively replaces the state of the two.

One of the states is that the free-end outer portion of the pressure boundary seal 202 is pressed against the inner wall of the pipe 1 strongly due to the fluid is injected into the space 203, another of the states is that the free-end outer portion of the pressure boundary seal 202 is separated from the inner wall of the pipe 1 due to the fluid is discharged from the space 203.

Described the function of the “Master valve with three ports and two positions 206”;

In the main unit 2 of the working device in the first preferred embodiment, the master valve 206 connects the in-port of the master valve 205 to the space B (B0) and connects the exhaust-port of the master valve 205 to the space A (A).

In the main unit 2 of the working device in the second preferred embodiment, the master valve 206 connects the in-port of the master valve 205 to the space A (A0) and connects the exhaust-port of the master valve 205 to the space B (B).

Describes in detail the actions of the first preferred embodiment of the “Working device for an internal pipe and working method for the same” described in the above, referring to the figures:

Being activated the roots type suction pump 31 having sufficient suction fluid volume, the water inside the space (A): A0 of the pipe 12 is sucked toward the downstream side—in other words—in the direction of the roots type suction pump 31, then the pressure in the space (A): A0 is reduced to the set pressure of the vacuum breaking system.

In the following, it is assumed that the set pressure of the vacuum breaking system is −200 mmHg.

Being reduced the pressure of the space (A): A0, the water inside the space (B): B0 flows into the space (A): A0 through a narrow gap between the surface of the pipe 12 and the free-end portion of the pressure boundary seal 20 as shown in FIG. 11.

The black arrow in the figure shows the direction that water flows through.

Because that the pressure of space (A): A0 is −200 mmHg whereas the pressure of space (B): B0 is almost atmospheric pressure due to the space (B) being opened in the manhole 14, the free-end portion 202 of the pressure boundary seal 20 is pushed strongly to the surface of the pipe 12 due to difference in pressure of the space (A): A0 and the space (B): B0, thus there become a fewer the gaps between the surface of the pipe 12 and the pressure boundary seal 20.

Described below about the phenomenon to be caused by actual gap between the surface of the pipe 12 and the pressure boundary seal 20, the high-speed water flow flows from the space (B): B0 into the space (A): A0 through the narrow gap due to the irregularity and the wound formed by rust on the surface of the pipe 12 and the pressure boundary seal 20.

In the vacuum breaking valve system shown in FIG. 11 in that the preset value of the pneumatic output unit 207 is −200 mmHg, the master valve 205 being maintained in the OFF when the pressure of the space (A): A0 is higher than −200 mmHg, then the pressure of the space 203 is maintained higher than the pressure of the space (A): A0 due to that the space 203 being connected to the space (B): B0.

Thus it is prevented, due to that the pressure boundary seal 202 is pressed strongly against the inner surface of the pipe 12, that the water flows into the space (A): A0 from the space (B): B0.

When the pressure of the space (A): A0 becomes less than −200 mmHg due to that the water is prevented to flows into the space (A): A0 from the space (B): B0, the master valve 205 becomes in the ON because the pneumatic output unit 207 outputs the air pressure to the master valve 205.

Then the pressure of the space 203 is reduced to a pressure close to the pressure of the space (A): A0 due to that the space 203 being connected to the space (A): A0.

Thus the water of the space (B): B0 flows into the space (A): A0 due to that the free-end outer portion of the pressure boundary seal 202 is separated from the inner wall of the pipe 12.

When the pressure of the space (A): A0 becomes over than −200 mmHg due to that the water of the space (B): B0 flows into the space (A): A0, the master valve 205 becomes again in the OFF because the pneumatic output unit 207 stops to output the air pressure to the master valve 205.

Then the space 203 is restarted to be connected to the space (B): B0.

Below, the above operation of the vacuum breaking valve system shown in FIG. 11 is repeated, and thus the pressure difference between the pressure of the space (A): A0 and the pressure of the space (B): B0 is maintained at an approximate value of 200 mmHg.

Described more about an important phenomenon, the main unit 2 receives strong power to act on a course of space (A): A0 from space (B): B0 due to difference in pressure of the space (A): A0 and the space (B): B0.

The output shaft of the geared air motor 31 rotating clockwise in the state that looked at the right from the left in FIG. 2; the main drive shaft 32, the universal joint 35, the driven shaft 36 and the spinning wheel unit 37 are rotated clockwise, thus the free-wheels 41 equipped with the spinning wheel unit 37 rotate.

Then, the travelling force acts on the spinning wheel unit 37 toward the right direction from the left along the axis of the pipe 1 due to that each of the axis of the free-wheels 41 slightly inclines counterclockwise seeing from the direction of the outer periphery of the pipe 12.

Then, the non-spinning wheel unit 38 being forced hardly to be rotated counterclockwise by the reaction, however the rotation is prevented due to that the free-wheels 41 is not forced to be rotate because each axis of the free-wheels 41 is arranged in a cross at right angle to the axis of the pipe 12.

Therefore, being rotated the geared air motor 31 clockwise in the state that looked at the right from the left in FIG. 2, the main unit 2 travels to the white arrow direction in FIG. 1.

In the case of this situation, the total driving force of the main unit 2 toward the white arrow direction becomes very big due to that the driving force of the spinning wheel unit 37 is added to the driving force that push the main unit 2 toward the white arrow direction being caused by difference in pressure −200 mmHg.

Being rotated the rotating brush 49 in FIG. 2, the surface of the pipe 12 is cleaned due to removed the rust or other foreign matter from the wall of the pipe 12.

Being transferred the suction water from the space (B): B0 to the roots type suction pump 31 through the space (A): A0, the hose 5 and the solid fluid separator 41, the clean water is released into the manhole 14 from the exit of the roots type suction pump 31 after separated the water from the removed particle by the solid-fluid separator 41.

Below, the water is recycled.

Described more about an important phenomenon, the high-speed water flow flowing from the space (B): B0 into the space (A): A0 through the narrow gap between the surface of the pipe 12 and the pressure boundary seal 20, thus the surface of the pipe 12 is cleaned in high quality by the action of the high-speed water flow.

The second preferred embodiment of the “Working device for an internal pipe and working method for the same” configured according to the present invention will be described in detail below, referring to the figures attached hereto.

In a difference with the main unit 2 of the first preferred embodiment and the main unit 2 of the second preferred embodiment, the constitution of the other parts is the same except the aspect of the vacuum breaking valve system or the pressure relief valve system.

Therefore, the drawings and the description are omitted here except the drawings and the description being related to the aspect of the vacuum breaking valve system or the pressure relief valve system.

In FIG. 12, the second preferred embodiment of the “Working device for an internal pipe and working method for the same” configured according to the present invention, comprising:

The main unit 2 placed inside the pipe 12;

The hose 5, of which downstream end being connected to the main unit 2, of which upstream end being connected to the outlet of the roots type pump 31;

The roots type pump 31 as a type of the positive-displacement pumps of which inlet is connected to the outlet of the solid-fluid separator 41;

The solid-fluid separator 41 which sucks the water stored in the manhole 14.

The stop valve 13 is connected to one end of the pipe 12 wherein the hose 5 is not placed.

Another end of the pipe 12 wherein placed of the hose 5 is released into the manhole 14.

The inside of the pipe 12 and the manhole 14 is filled with water.

Described below the difference with the main unit 2 of the first preferred embodiment and the main unit 2 of the second preferred embodiment:

In the main unit 2 of the first preferred embodiment, there is the vacuum breaking system that the excessive negative pressure of the space (A) is prevented by flowing the fluid into the space (A) from the space (B).

In the main unit 2 of the second preferred embodiment, there is the pressure relief valve system that the excessive positive pressure of the space (A) is prevented by flowing the fluid into the space (B) from the space (A).

In the main unit 2 of the second preferred embodiment, the pressure boundary seal 20 is used for the valve sheet of the pressure relief valve system as shown in FIG. 10 though it is possible to use a known pressure relief valve.

Describes in detail the actions of the second preferred embodiment of the “Working device for an internal pipe and working method for the same” described in the above, referring to the figures:

Being activated the roots pump 31 having sufficient fluid volume, the water being injected into the space (A): A0 of the pipe 12, the pressure of the space (A): A0 is increased to the set pressure of the pressure relief valve system.

In the following, it is assumed that the set pressure of the pressure relief valve system is 200 mmHg.

Being increased the pressure of the space (A): A0, the water inside the space (A): A0 flows into the space (B): B0 through a narrow gap between the surface of the pipe 12 and the free-end portion of the pressure boundary seal 20 as shown in FIG. 13.

The black arrow in the figure shows the direction that water flows through.

Because that the pressure of the space (A): A0 is 200 mmHg whereas the pressure of space (B): B0 is almost atmospheric pressure due to the space (B) being opened in the manhole 14, the free-end portion 202 of the pressure boundary seal 20 is pushed strongly to the surface of the pipe 12 due to difference in pressure of the space (A): A0 and the space (B): B0, thus there become a fewer the gaps between the surface of the pipe 12 and the pressure boundary seal 20.

Described below about the phenomenon to be caused by actual gap between the surface of the pipe 12 and the pressure boundary seal 20, the high-speed water flow flows from the space (A): A0 into the space (B): B0 through the narrow gap due to the irregularity and the wound formed by rust on the surface of the pipe 12 and the pressure boundary seal 20.

In the pressure relief valve system shown in FIG. 13 in that the preset value of the pneumatic output unit 207 is 200 mmHg, the master valve 205 being maintained in the OFF when the pressure of the space (A): A0 is lower than 200 mmHg, then the pressure of the space 203 is maintained higher than the pressure of the space (B): B0 due to that the space 203 being connected to the space (A): A0.

Thus it is prevented, due to that the pressure boundary seal 202 is pressed strongly against the inner surface of the pipe 12, that the water flows into the space (A): A0 from the space (B): B0.

When the pressure of the space (A): A0 becomes over than 200 mmHg due to that the water is prevented to flows into the space (B): B0 from the space (A): A0, the master valve 205 becomes in the ON because the pneumatic output unit 207 outputs the air pressure to the master valve 205.

Then the pressure of the space 203 is reduced to a pressure close to the pressure of the space (B): B0 due to that the space 203 being connected to the space (B): B0.

Thus the water of the space (A): A0 flows into the space (B): B0 due to that the free-end outer portion of the pressure boundary seal 202 is separated from the inner wall of the pipe 12.

When the pressure of the space (A): A0 becomes less than 200 mmHg due to that the water of the space (A): A0 flows into the space (B): B0, the master valve 205 becomes again in the OFF because the pneumatic output unit 207 stops to output the air pressure to the master valve 205.

Then the space 203 is restarted to be connected to the space (A): A0.

Below, the above operation of the pressure relief valve system shown in FIG. 13 is repeated, and thus the pressure difference between the pressure of the space (A): A0 and the pressure of the space (B): B0 is maintained at an approximate value of 200 mmHg.

Described more about an important phenomenon, the main unit 2 receives strong power to act on a course of space (B): B0 from space (A): A0 due to difference in pressure of the space (A): A0 and the space (B): B0.

The output shaft of the geared air motor 31 rotating clockwise in the state that looked at the right from the left in FIG. 2; the main drive shaft 32, the universal joint 35, the driven shaft 36 and the spinning wheel unit 37 are rotated clockwise, thus the free-wheels 41 equipped with the spinning wheel unit 37 rotate.

Then, the travelling force acts on the spinning wheel unit 37 toward the right direction from the left along the axis of the pipe 1 due to that each of the axis of the free-wheels 41 slightly inclines counterclockwise seeing from the direction of the outer periphery of the pipe 12.

Then, the non-spinning wheel unit 38 being forced hardly to be rotated counterclockwise by the reaction, however the rotation is prevented due to that the free-wheels 41 is not forced to be rotate because each axis of the free-wheels 41 is arranged in a cross at right angle to the axis of the pipe 12. Therefore, being rotated the geared air motor 31 clockwise in the state that looked at the right from the left in FIG. 2, the main unit 2 travels to the white arrow direction in FIG. 1.

In the case of this situation, the total driving force of the main unit 2 toward the white arrow direction becomes very big due to that the driving force of the spinning wheel unit 37 is added to the driving force that push the main unit 2 toward the white arrow direction being caused by difference in pressure −200 mmHg.

The preferred embodiments of the present invention are described in the above, however it is possible to conceive the other various embodiments based on the scope of the claims. In the first and second preferred embodiments, the main unit has the spinning wheel unit and the non-spinning wheel unit as the means to make the main unit to move inside the pipe.

Describes in detail the configuration of the spinning wheel unit, comprising:

Four sets of the non-rotating rod cylinders being installed radially on the periphery of the rotating body;

Two free-wheels being installed in the each ends of the piston rods of the non-rotating rod cylinders;

Each axis of the free-wheels is arranged in a cross at a small angle to the axis of the pipe;

The means to extend the piston rods of the non-rotating rod cylinders in order to push strongly the free-wheels to the surface of the pipe such as the means to supply the pressure fluid to the cylinders or the compression coil spring which is placed inside each of the cylinders.

Describes in detail the configuration of the non-spinning wheel unit, comprising:

Four sets of the non-rotating rod cylinders being installed radially on the periphery of the non-rotating body;

Two free-wheels being installed in the each ends of the piston rods of the non-rotating rod cylinders;

Each axis of the free-wheels is arranged in a cross at right angle to the axis of the pipe;

The means to extend the piston rods of the non-rotating rod cylinders in order to push strongly the free-wheels to the surface of the pipe such as the means to supply the pressure fluid to the cylinders or the compression coil spring which is placed inside each of the cylinders.

As to the means to make the main unit to travel inside the pipe, it is not limited to the means described in the above.

For example, a winch may be used to move the main unit along the pipe by pulling the main unit via a wire rope which is wound off by the winch.

The descriptions in the above of the preferred embodiments of the present invention assumed that the device of the present invention existed in the water, but the device of the present invention may be applied in the atmosphere.

This invention relates to a working device or a working method capable of moving along the surface of an internal pipe, having a repair device/s that acts on the surface of the internal pipe, such a repair device may be a cleaning device to remove foreign matter such as rust or aquatic organisms attached to the internal pipe such as a clear-water pipe, drainage or gas pipe.

### BRIEF DESCRIPTION OF THE DRAWING

FIG. 1 is a overall view of the first preferred embodiment of the “Working device for an internal pipe and working method for the same” configured according to the present invention, showing the configuration of the first preferred embodiment of the working device that includes the main unit and ancillary related equipments.

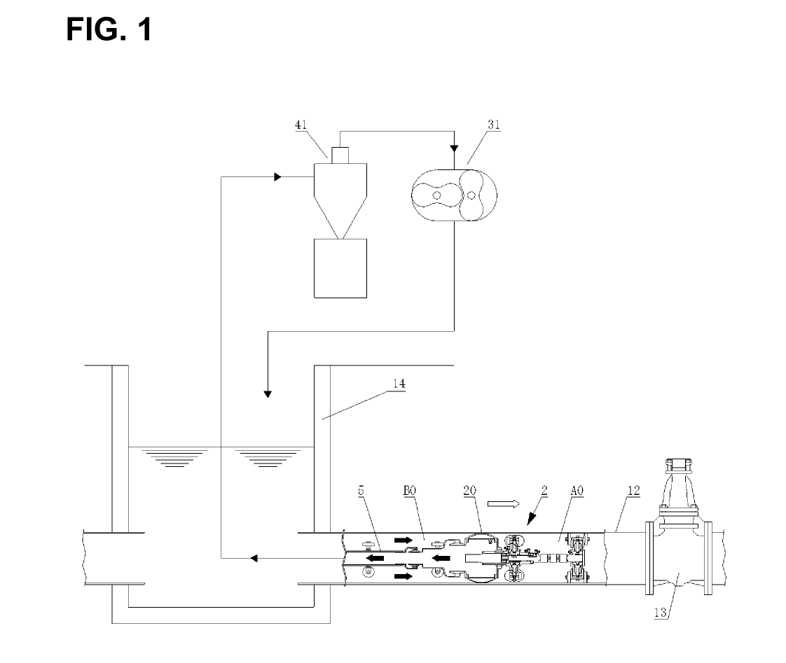

FIG. 2 is an enlarged section view of the main unit of the working device shown in FIG. 1.

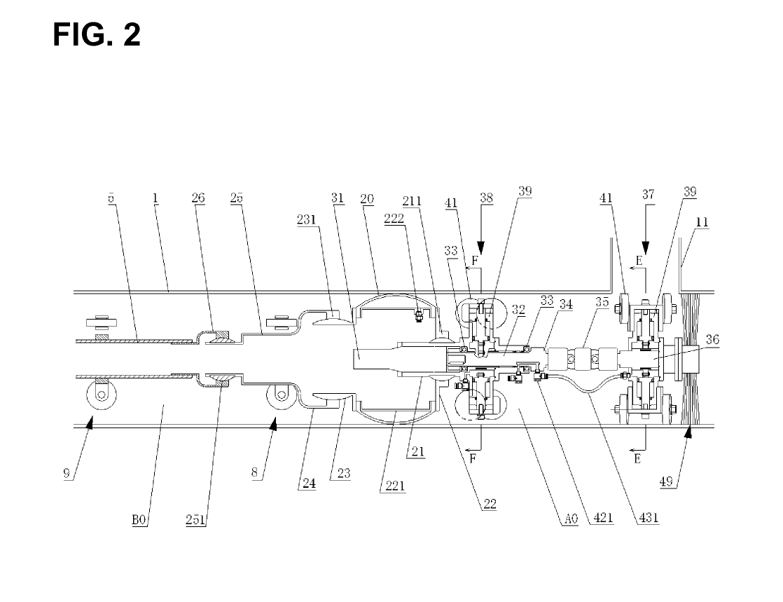

FIG. 3 is a top view of the main unit shown in FIG. 2.

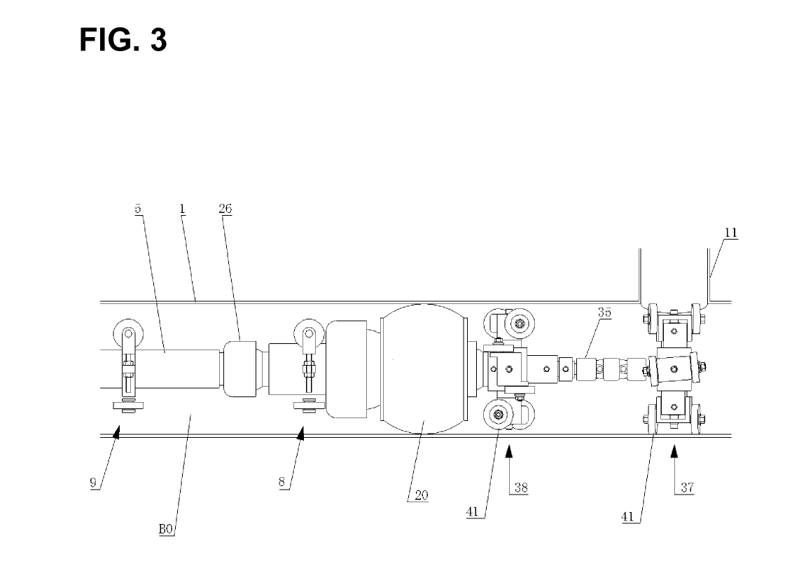

FIG. 4 is an enlarged section view from the arrows E-E of the main unit shown in FIG. 2.

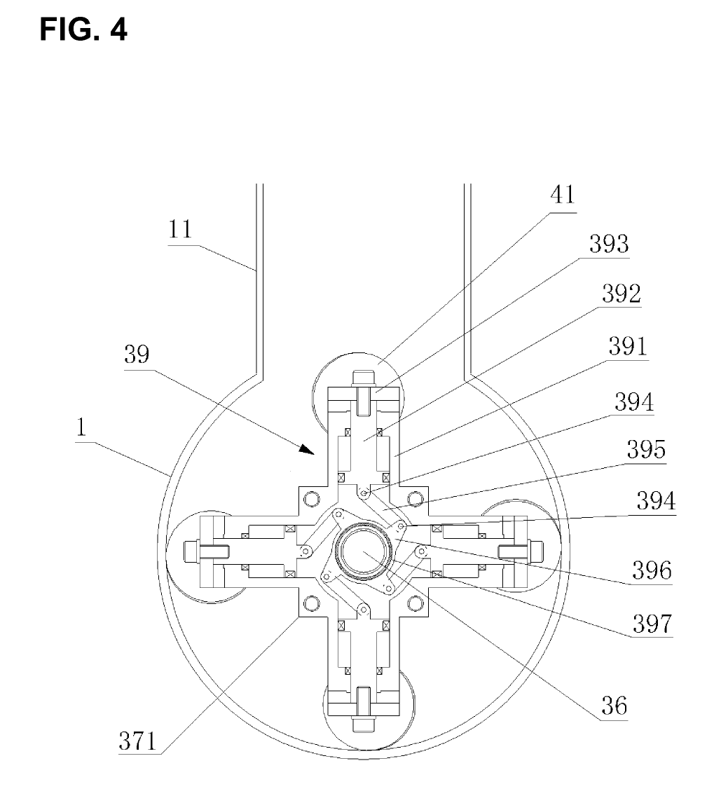

FIG. 5 is an enlarged section view from the arrows F-F of the main unit shown in FIG. 2.

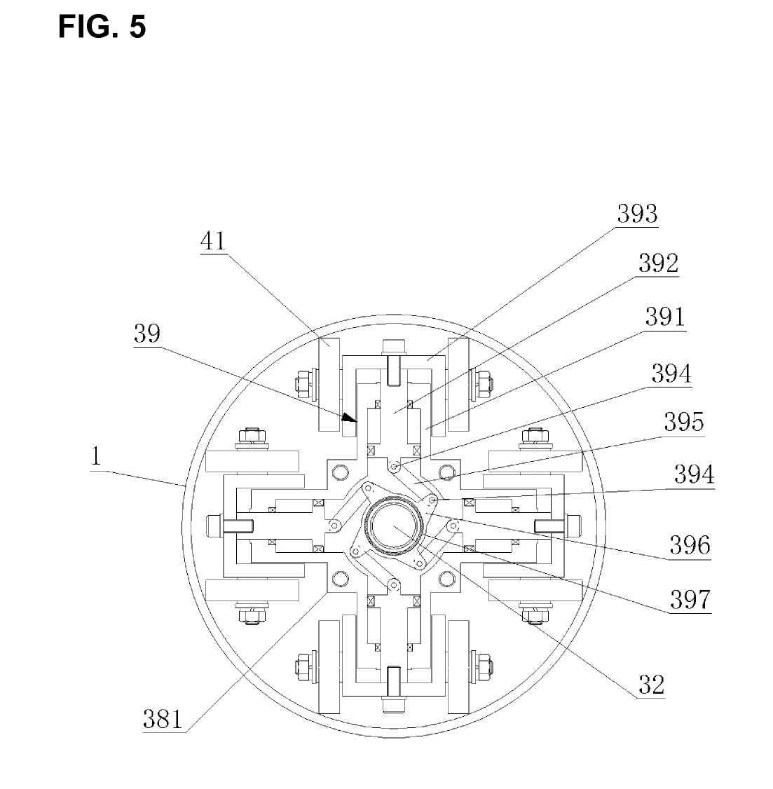

FIG. 6 is an enlarged section view of the spinning wheel unit of the main unit shown in FIG. 2.

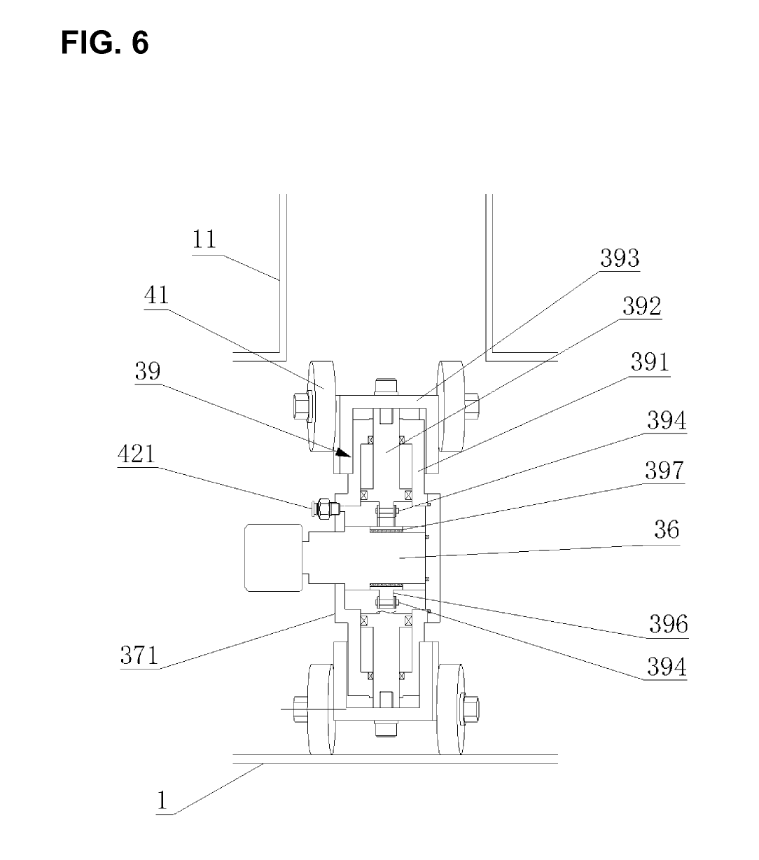

FIG. 7 is an enlarged section view of the non-spinning wheel unit of the main unit shown in FIG. 2.

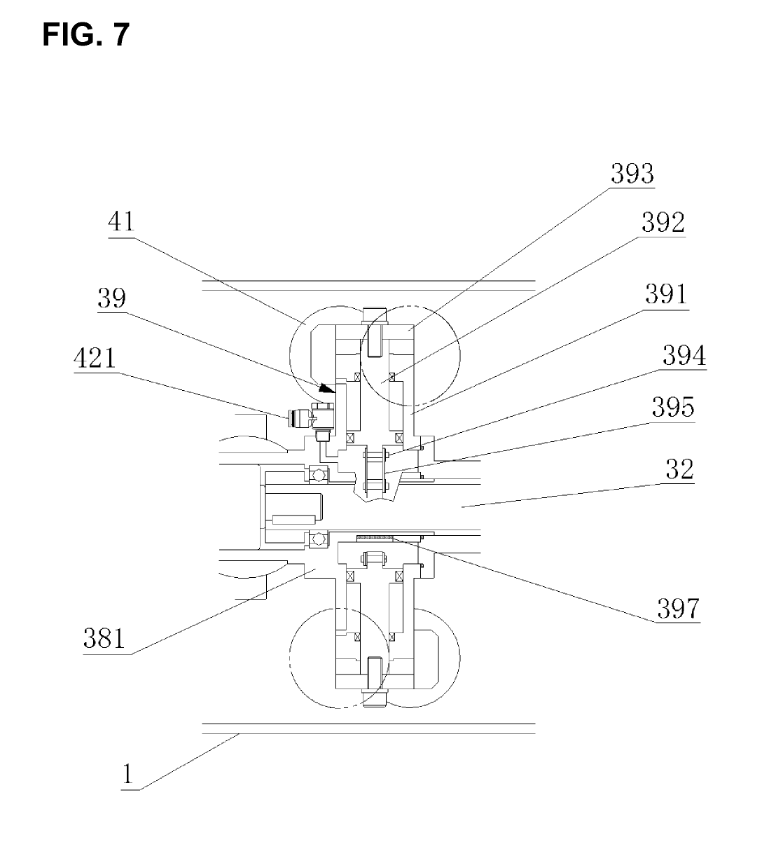

FIG. 8 is a section view which shows the state in that the piston rods of the non-rotating rod cylinders are retracted shown in FIG. 4.

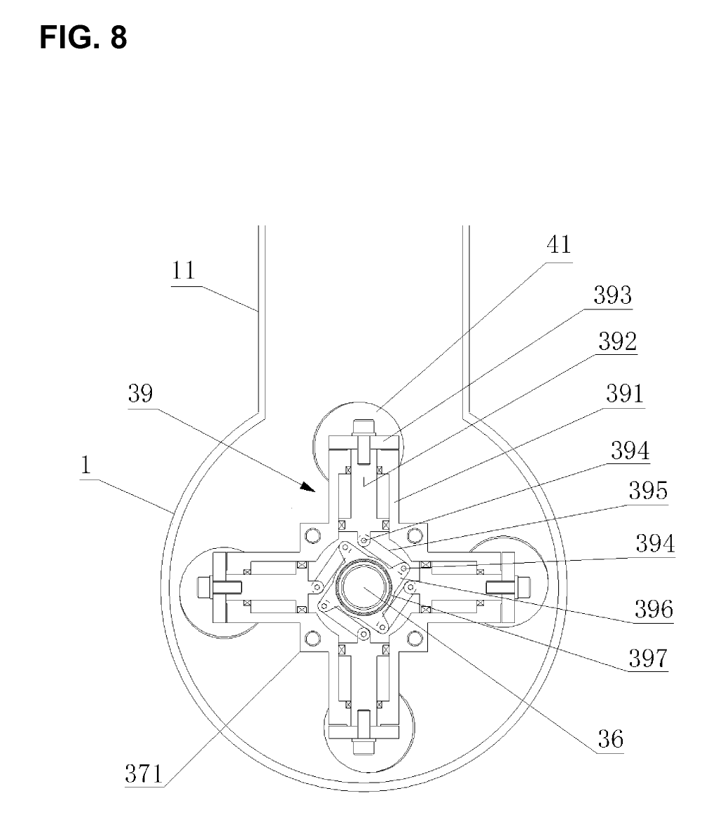

FIG. 9 is a section view which shows the state in that the piston rods of the non-rotating rod cylinders are retracted shown in FIG. 5.

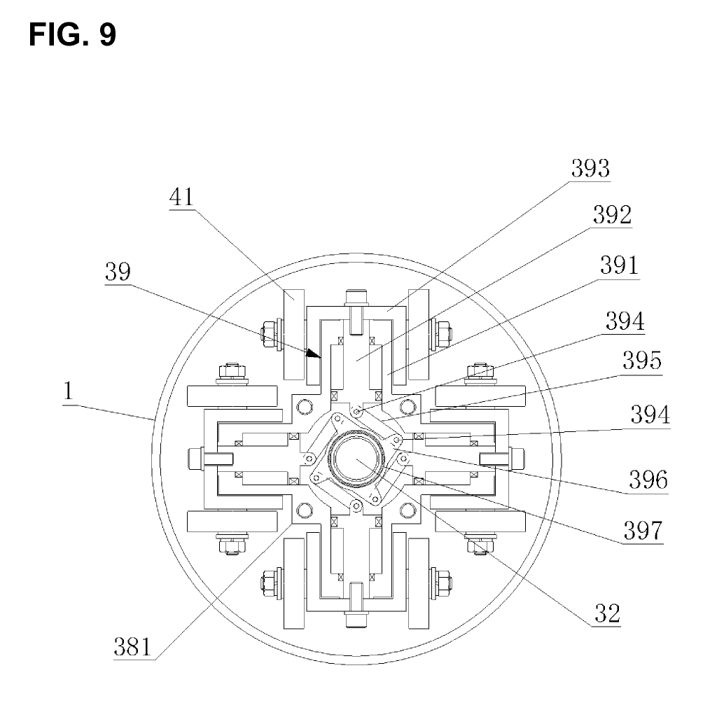

FIG. 10 is an enlarged section view which shows the piping of the pressure boundary seal part of the main unit shown in FIG. 1 and FIG. 12.

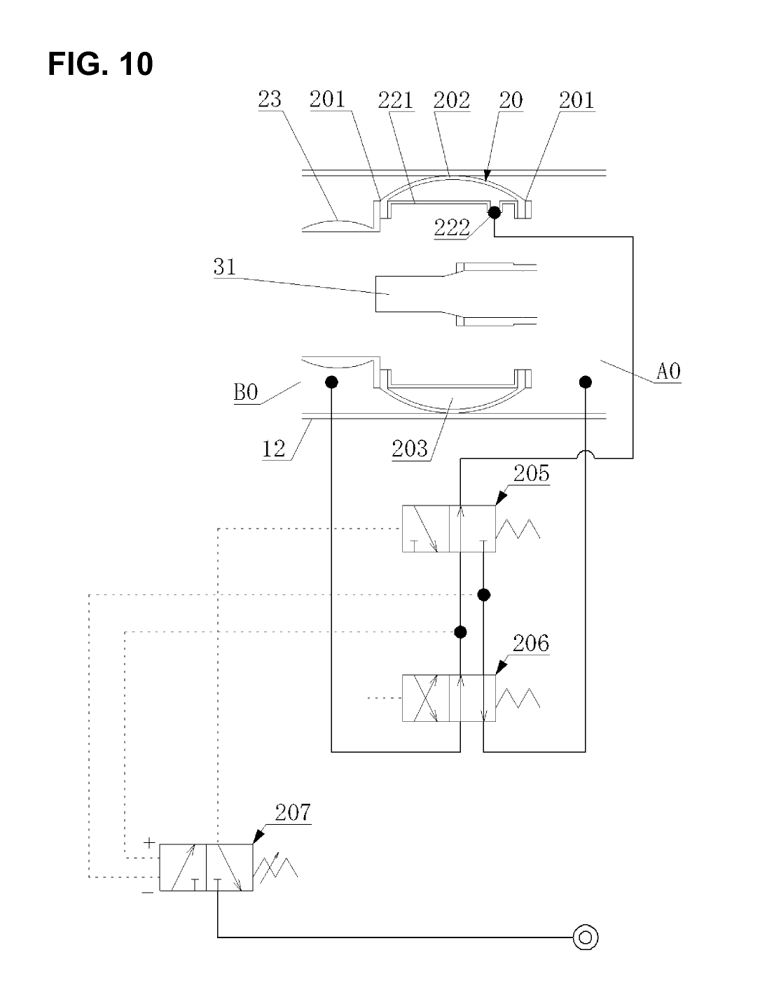

FIG. 11 is an enlarged section view which shows the piping of the pressure boundary seal part of the main unit shown in FIG. 1.

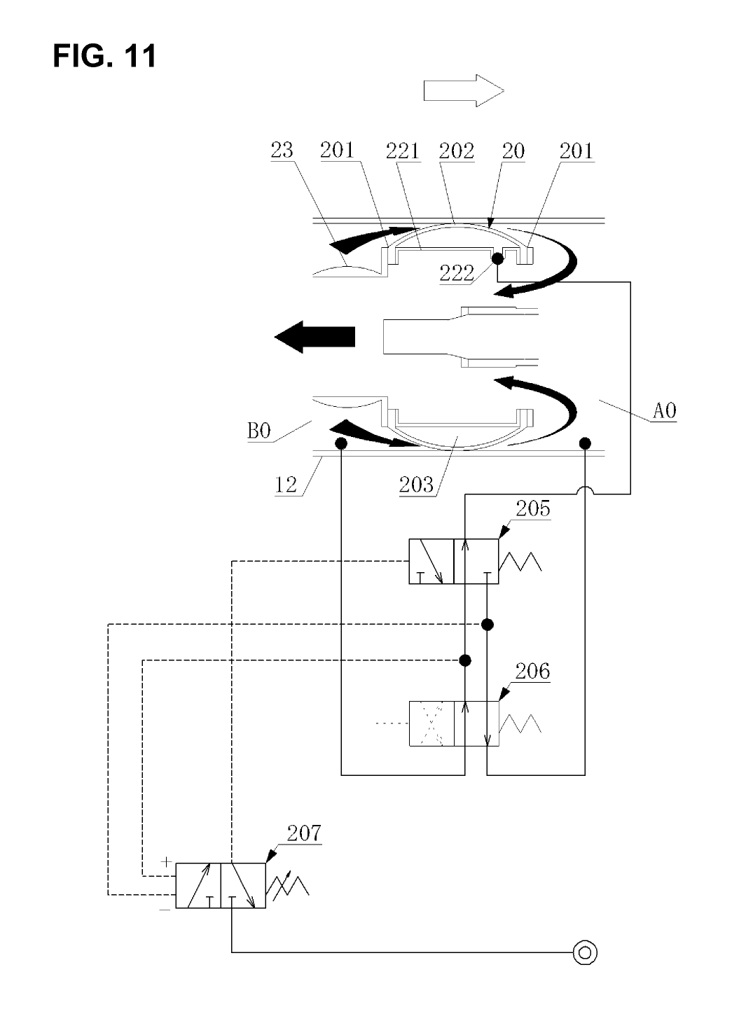

FIG. 12 is an overall view of the second preferred embodiment of the “Working device for an internal pipe and working method for the same” configured according to the present invention, showing the configuration of the second preferred embodiment of the working device that includes the main unit and ancillary related equipments.

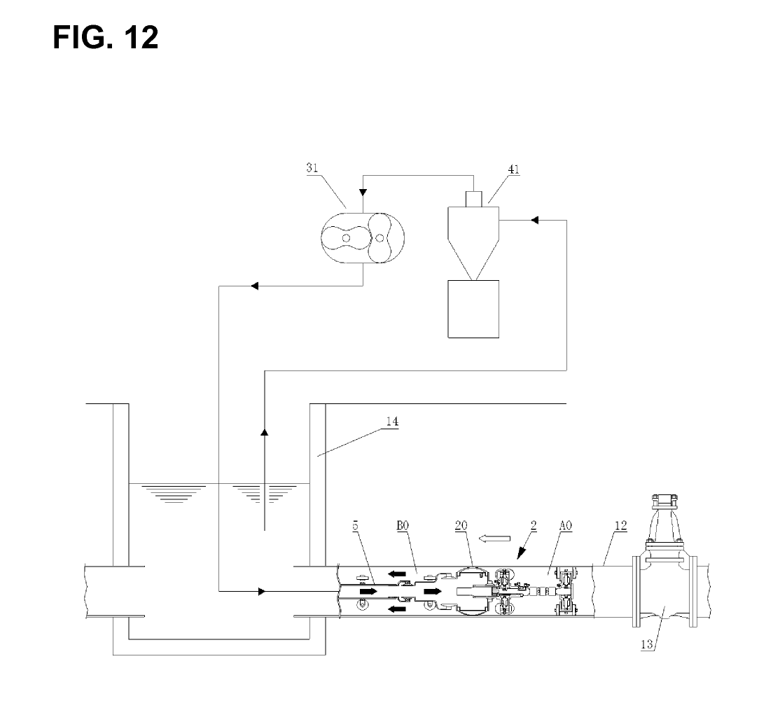

FIG. 13 is an enlarged section view which shows the piping of the pressure boundary seal part of the main unit shown in FIG. 12.

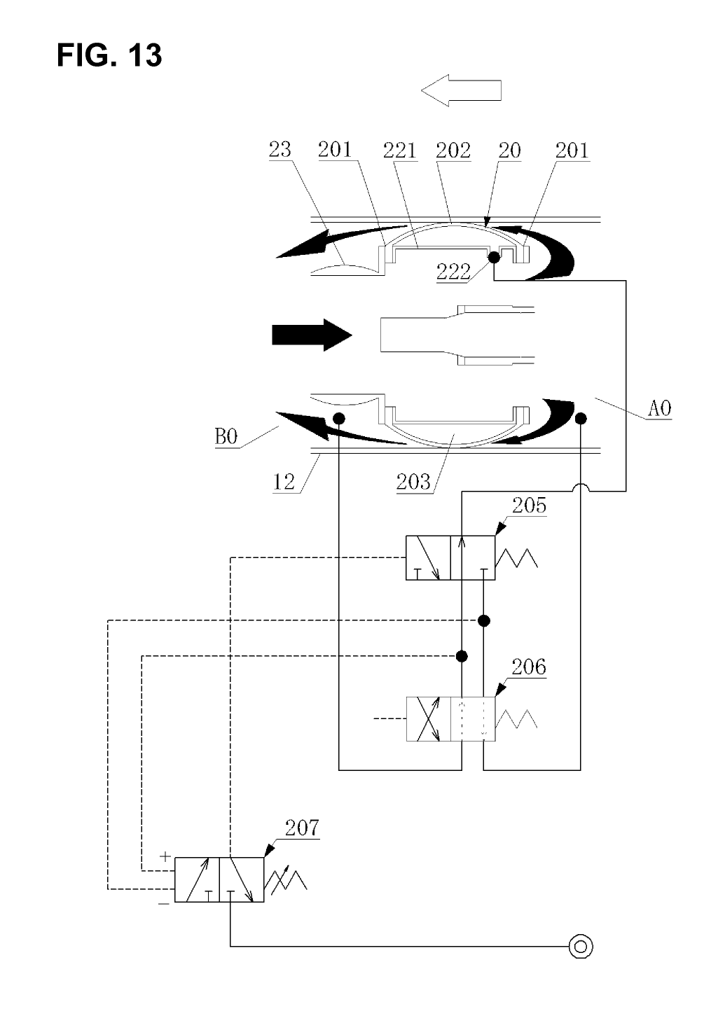

### REFERENCE NUMERALS OR MARKES

A0 space(A); B0 space(B); 5 hose; 8 guide wheel unit; 9 guide wheel unit for hose; 2 main unit; 20 pressure boundary seal; 201 fixed portion; 202 free-end portion; 203 space inside pressure boundary seal; 31 geared air motor; 31 main drive shaft; 33 ball bearing; 34 rotary joint; 35 universal joint; 36 driven shaft; 21 the first cylindrical body; 22 the second cylindrical body; 23 the third cylindrical body; 24 the fourth cylindrical body; 25 the fifth cylindrical body; 26 hose connector; 211 the first spherical bearing; 231 the second spherical bearing; 251 the third spherical bearing; 37 spinning wheel unit; 38 non-spinning wheel unit; 41 driven wheel; 11 branch pipe; 12 pipe; 13 stop valve; 14 manhole; 31 roots type pump; 14 solid fluid separation device; 9 rotating brush; 221 seal fixing cylindrical body; 222 fluid fitting; 421 fluid fitting; 431 fluid tube; 371 cylinder base for spinning wheel unit; 381 cylinder base for non-spinning wheel unit; 391 cylinder case; 392 piston rod; 394 link pin; 395 link plate; 396 swing lever; 397 bush bearing; 205 master valve; 206 master valve; 207 pneumatic output unit; 208 air compressor; + input port for high pressure side comparison signal air; − input port for low pressure side comparison signal air:

1. A working device capable of moving along an internal surface of a pipe, comprising:
a pressure boundary seal with an annular shape having a free-end portion contacting with the surface of the internal surface of the pipe,
wherein said pressure boundary seal is arranged as a boundary to separate a space inside the pipe into a space (A) and a space (B),
an end portion of the space (A) adjacent to the pressure boundary seal is connected with a suction pump via a hose,
said end portion of the space (A) adjacent to the pressure boundary seal is also connected with the space (B) via a vacuum breaker that adjusts a negative pressure within the space (A),
the other end portion of the space (A), which is not adjacent to the seal, is closed, and
said hose is disposed in the space (B).

2. A working device capable of moving along an internal surface of a pipe, comprising:
a pressure boundary seal with an annular shape having a free-end portion contacting with the internal surface of the pipe,
wherein said pressure boundary seal is arranged as a boundary to separate a space inside the pipe into a space (A) and a space (B),
an end portion of the space (A) adjacent to the pressure boundary seal is connected with a delivery pump via a hose,
said end portion of space (A) adjacent to the seal is also connected with the space (B) via a relief valve that adjusts a positive pressure within the space (A),
the other end portion of the space (A), which is not adjacent to the seal, is closed, and
said hose is disposed in the space (B).

3. A working device capable of moving along an internal surface of a pipe and a method, comprising:
a first process of moving the working device according to claim 1 in a direction from the space (B) toward the space (A); and
a second process of moving the working device according to claim 2 in a direction from the space (A) toward the space (B).

4. The working device capable of moving along the internal surface of the pipe according to one of claims 1 to 3, further comprising a vacuum breaking valve mechanism or a relief valve mechanism,
wherein said pressure boundary seal includes two fixing portions fixed to both end portions of a cylindrical body of a main body of the working device,
said free-end portion extends in a direction toward the internal surface of the pipe to contact with the internal surface,
said free-end portion has two extending portions being combined to have an arc-shape,
said pressure boundary seal and said cylindrical body form a closed annular space,
a valve is disposed for injecting a fluid into or discharges the fluid from the closed annular space,
said fluid is discharged from the closed annular space to contract and move the pressure boundary seal away from the inner surface of the pipe when the negative pressure of the space (A) becomes excessive so that the fluid in the space (B) flows into the space (A) to prevent the negative pressure of the space (A) from increasing, and
said fluid is discharged from the closed annular space to contract and move the pressure boundary seal away from the inner surface of the pipe when the positive pressure of the space (A) becomes excessive so that the fluid in the space (A) flows into the space (B) to prevent the positive pressure of the space (A) from increasing.

5. A working device capable of moving along an internal surface of a pipe, comprising:
a spinning wheel unit as means to move the working device along the internal surface of the pipe; and
a non-spinning wheel unit as the means to move the working device along the internal surface of the pipe,
wherein said spinning wheel unit comprises:
a plurality of non-rotating rod cylinders radially arranged on an outer periphery of a rotating body;
free-wheels each being disposed on each of the non-rotating rod cylinders, each of said free-wheels having an axis being inclined relative to an axis of the pipe; and
means for supplying a pressurized fluid to the non-rotating rod cylinders so that the non-rotating rod cylinders push the free-wheels to the internal surface of the pipe, or a compression coil spring placed inside the non-rotating rod cylinders,
said non-spinning wheel unit comprises:
a plurality of non-rotating rod cylinders radially arranged on an outer periphery of a non-rotating body;
free-wheels each being disposed on each of the non-rotating rod cylinders, each of said free-wheels having an axis being inclined relative to the axis of the pipe;
means for supplying a pressurized fluid to the non-rotating rod cylinders so that the non-rotating rod cylinders push the free-wheels to the internal surface of the pipe, or a compression coil spring placed inside the non-rotating rod cylinders,
said non-rotating rod cylinders of the spinning wheel unit include a swing lever having lever parts radially arranged on an outer periphery thereof in a number the same as that of the non-rotating rod cylinders, a link plate for connecting the lever parts and piston rods, and a link pin so that the piston rods are synchronized, and
said non-rotating rod cylinders of the non-spinning wheel unit include a swing lever having lever parts radially arranged on an outer periphery thereof in a number the same as that of the non-rotating rod cylinders, a link plate for connecting the lever parts and piston rods, and a link pin so that the piston rods are synchronized.
